(19) United States
(12) Patent Application Publication
(10) Pub. No.: US 2007/0007910 A1
(43) Pub. Date: Jan. 11, 2007

(54) Current balancing techniques for fluorescent lamps

(75) Inventors: Sangsun Kim, San Jose, CA (US); Wei Chen, Campbell, CA (US)

Correspondence Address: PERKINS COIE LLP;PATENT-SEA, P.O. BOX 1247, SEATTLE, WA, 98111-1247, US

(73) Assignee: Monolithic Power Systems, Inc., Los Gatos, CA (US)

(21) Appl. No.: 11/454,093

(22) Filed: Jun. 14, 2006

Related U.S. Application Data
(63) Continuation-in-part of application No. 11/191,129, filed on Jul. 27, 2005.
Application No. 11/191,129 is a continuation-in-part of application No. 11/176,804, filed on Jul. 6, 2005.

(51) Int. Cl. H05B 41/24

(52) U.S. Cl. 315/282

(57) ABSTRACT

Methods and apparatus are disclosed for balancing currents passing through multiple circuit loads and in some cases through fluorescent lamps. Multiple-leg magnetic cores are wound in specific manners to simplify current balancing. Conventional three- or more than three-legged EE- and EI-type magnetic cores, with disclosed windings are used to balance current in circuits with multiple branches, such as connected Cold Cathode Fluorescent Lamps (CCFLs).

### CROSS-REFERENCE TO RELATED APPLICATION

This application is a Continuation-In-Part of U.S. patent application Ser. No. 11/191,129, entitled “Equalizing Discharge Lamp Currents in Circuits,” filed Jul. 27, 2005, which is a Continuation-In-Part of U.S. patent application Ser. No. 11/176,804, entitled “Current Balancing Technique with Magnetic Integration for Fluorescent Lamps,” filed Jul. 6, 2005.

### TECHNICAL FIELD

The embodiments described below relate, generally, to current balancing in multiple parallel branches of a circuit and, particularly, to current balancing in Cold Cathode Fluorescent Lamps (CCFLs).

### BACKGROUND

Fluorescent lamps provide illumination in typical electrical devices for general lighting purposes and are more efficient than incandescent bulbs. A fluorescent lamp is a low pressure gas discharge source, in which fluorescent powders are activated by an arc energy generated by mercury plasma. When a proper voltage is applied, an arc is produced by current flowing between the electrodes through the mercury vapor, which generates some visible radiation and the resulting ultraviolet excites the phosphors to emit light. In fluorescent lamps two electrodes are hermetically sealed at each end of the bulb, which are designed to operate as either “cold” or “hot” cathodes or electrodes in glow or arc modes of discharge operation.

Cold cathode fluorescent lamps (CCFLs) are popular in backlight applications for liquid crystal displays (LCDs). Electrodes for glow or cold cathode operation may consist of closed-end metal cylinders that are typically coated on the inside with an emissive material. The current used by CCFLs is generally on the order of a few milliamperes, while the voltage drop is on the order of several hundred volts.

CCFLs have a much longer life than the hot electrode fluorescent lamps as a result of their rugged electrodes, lack of filament, and low current consumption. They start immediately, even at a cold temperature, and their life is not affected by the number of starts, and can be dimmed to very low levels of light output. However, since a large number of lamps are required for large size LCDs, balanced current sharing among lamps is required for achieving uniform backlight and long lamp life.

One means of current balancing is to drive each lamp with an independently controlled inverter, which achieves high accuracy in current sharing; however, this approach is usually complicated and expensive. Another solution is to drive all lamps with a single inverter. FIG. 1 depicts a multi-CCFL system comprising a low voltage inverter, a step-up transformer, and current balancing transformers. This technique is more cost effective. Currently there are a few current balancing transformer techniques, two of which are shown in FIGS. 2A and 2B. In these designs, the current balancing is not available under open lamp condition.

### BRIEF DESCRIPTION OF THE DRAWINGS

FIG. 1 illustrates a multi-lamp system driven by a single inverter.

FIGS. 2A and 2B illustrate prior art multi-lamp current balancing systems.

FIG. 3 illustrates an exemplary current balancing technique for multi-lamp systems, in accordance with an embodiment of the invention.

FIGS. 4A and 4B illustrate structures of two integrated transformers with 3-leg magnetic core, in accordance with two other embodiments of the invention.

FIG. 5 illustrates an example of a 4-winding 3-Lamp current balancing technique with a single magnetic core, in accordance with yet anther embodiment of the invention.

FIG. 6 illustrates a star-delta configuration of a 3-Lamp current balancing technique, using a single magnetic core, in accordance with yet anther embodiment of the invention.

FIG. 7 illustrates a multi-leg magnetic core with zig-zag connection for current balancing in a multi-lamp system.

FIG. 8 illustrates a multi-leg magnetic core with star-delta connection for current balancing in a multi-lamp system.

FIGS. 9A, 9B and 9C illustrate transformer configurations for balancing the current in more than three parallel lamps, using several multi-legged transformers with different windings, in accordance with other alternative embodiments of the invention.

FIG. 10 shows a multi-leg magnetic core with star-open-delta connection to balance currents in more lamps than total number of magnetic core legs, in accordance with yet anther embodiment of the invention.

FIGS. 11A and 11B illustrate current balancing methods using common mode chokes (CMCs).

FIGS. 12A and 12B illustrate winding details of the CMCs shown in FIGS. 11A and 11B.

FIG. 13 illustrates a current balancing method for 4-lamp application using a single CMC.

FIG. 14A shows a current balancing method for 6-lamp application using two CMCs, and FIG. 14B shows an integration method of implementing the CMCs of FIG. 14A with a single magnetic.

FIGS. 15A and 15B show a method for integration of transformer and CMC of FIG. 13 into a single magnetic.

FIG. 16 shows a current balancing method for multiple loads, using a single CMC.

FIGS. 17A and 17B show a current balancing method for a circuit such as the one shown in FIG. 16, using a single magnetic core on which a main transformer and CMCs are wound.

FIG. 18 shows a current balancing method using a coupled inductor.

FIGS. 19A and 19B show a lamp current balancing method with an integrated magnetic core implementing a main transformer and CMCs.

FIGS. 20A-20D depict some disclosed cells in which current balancing for 2, 4, and 6 lamps are achieved.

FIG. 21 illustrates a multi-lamp current-balancing circuit in which currents of more than six lamps are balanced.

FIG. 22 shows a detailed example of the circuit illustrated in FIG. 21.

FIG. 23 depicts integrating any CMC, used in FIG. 21, with a single or a multi-core magnetic structure.

FIG. 24 shows a current balancing solution with a coupled inductor.

FIG. 25 shows a balancing circuit with two different voltage inputs that are normally out of phase.

FIGS. 26A and 26B show coupled inductors connected to a single and two polarities of transformers.

FIG. 27 shows a lamp current balancing circuit with a fully integrated multi-leg magnetic core with a zig-zag connection.

FIG. 28 shows another current balancing circuit with a star-delta connection on a multi-leg transformer with at least one empty leg.

FIG. 29 illustrates an extension of the circuits shown in FIGS. 27 and 28 which supports multiple lamps.

FIG. 30A shows a circuit replacing the inductors of FIG. 24 with multi-inductors with a single bobbin with an EI-type core.

FIGS. 31A and 31B show multi-CMCs with a single bobbin structure.

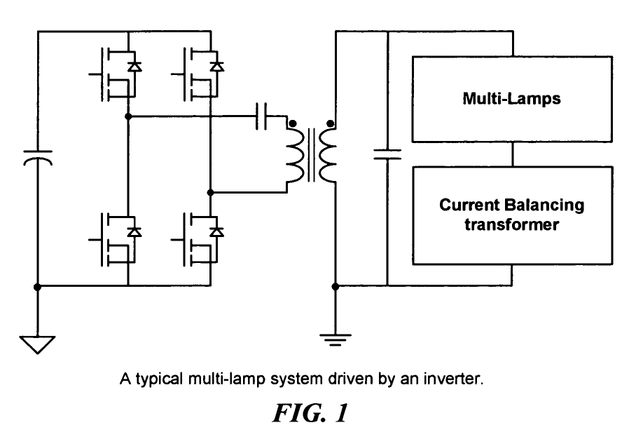

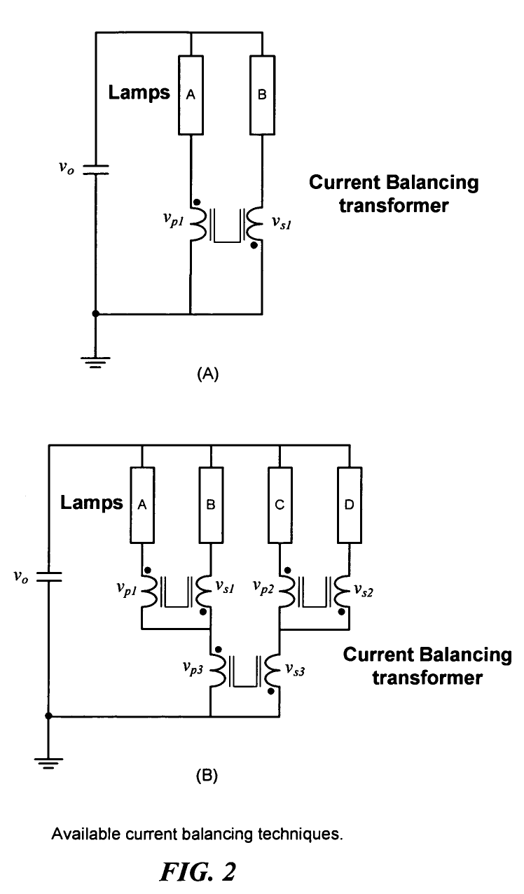

### DETAILED DESCRIPTION

The embodiments described in this detailed description generally employ a single multiple-legged transformer with multiple windings, making it a simple and accurate circuit to achieve balanced currents through all participating lamps and to reject unwanted parasitic and harmonics. A few of the advantages of the presented embodiments are accurate current balancing, reduction of the number of magnetic cores, low manufacturing cost, small size, and current balancing under open lamp conditions.

The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

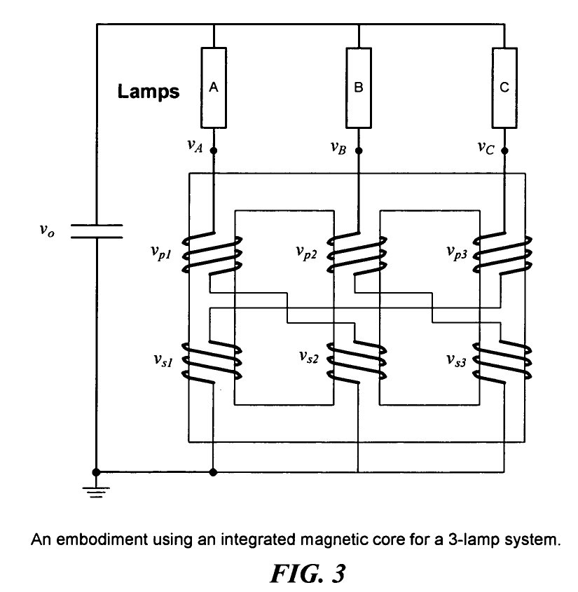

FIG. 3 shows a current balancing circuit with a zig-zag connection to balance currents passing through the lamps of a 3-lamp system. From FIG. 3, assuming that the three transformers (one on each leg) are ideal and turns ratio is 1:1, two winding voltages on the same magnetic core have the following relationship:
vₚ₁=−vₛ₁
vₚ₂=−vₛ₂
vₚ₃=−vₛ₃ (1)
The voltage equations on the terminals A, B, and C are:

$$[ \begin{matrix}{v}_{A} \\ {v}_{B} \\ {v}_{C}\end{matrix} ] = [ \begin{matrix}{v}_{p 1} + {v}_{s 2} \\ {v}_{p 2} + {v}_{s 3} \\ {v}_{p 3} + {v}_{s 1}\end{matrix} ] [ \begin{matrix}{v}_{p 1} - {v}_{p 2} \\ {v}_{p 2} - {v}_{p 3} \\ {v}_{p 3} - {v}_{p 1}\end{matrix} ] [ \begin{matrix}1 & - 1 & 0 \\ 0 & 1 & - 1 \\ - 1 & 0 & 1\end{matrix} ] [ \begin{matrix}{v}_{p 1} \\ {v}_{p 2} \\ {v}_{p 3}\end{matrix} ] \qquad ( 2 )$$

and therefore:
v_{A}+v_{B}+v_{C}=0, (3)
and
vₚ₁+vₚ₂+vₚ₃=0. (4)

From equation (4) it can be concluded that three separate transformers may be integrated together to provide a more compact and a less expensive solution. The resulting transformer is a kind of autotransformer that does not provide isolation. In one embodiment the cross section of the three legs are identical and each leg has two windings and the connections are made according to FIG. 3. The magnetic core can be an EE type core since it is the most commonly used. In other embodiments, other types of balanced three leg cores may be used for achieving a balanced inductance on each leg.

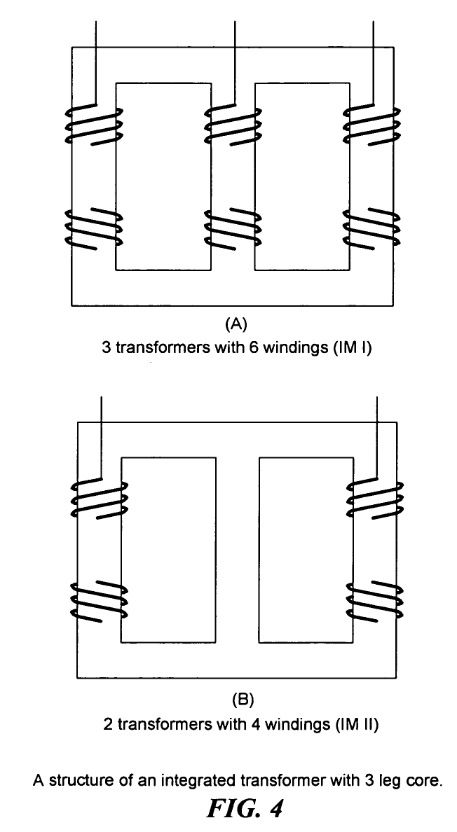

FIG. 4 illustrates a three-legged integrated transformer structure with two different winding options. In one option, as shown in FIG. 4A, all legs have windings, while in the second option, as shown in FIG. 4B, only two of the three legs have windings. Note that for the current in the three lamps to be balanced, the leg without winding does not have to be balanced with the other two legs. Therefore any available EE type magnetic core can be used for this option.

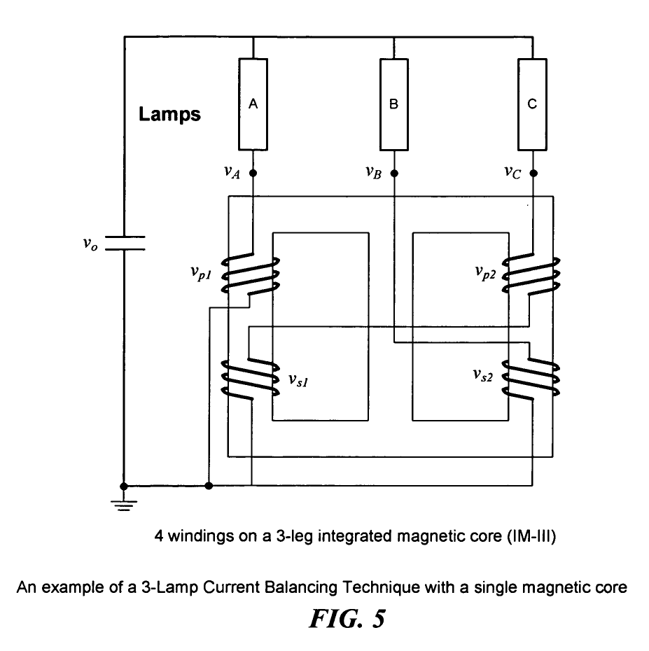

FIG. 5 shows winding details of an embodiment, which is similar to the embodiment depicted in FIG. 4B, wherein only two legs of the integrated magnetic core have windings. This embodiment provides current balancing for a 3-lamp system.

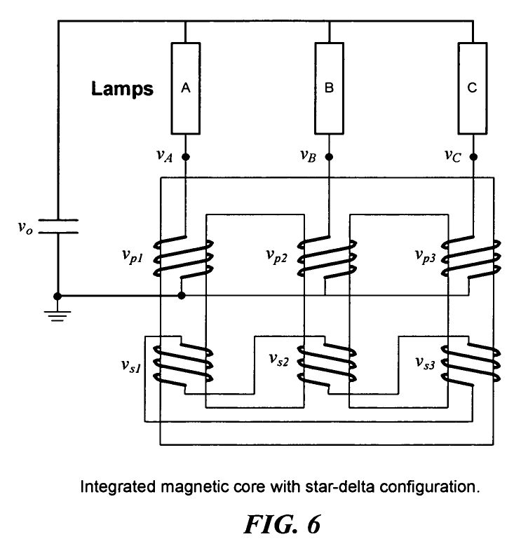

FIG. 6 shows winding details of an alternative current balancing transformer with a star-delta connection for balancing the current in a 3-lamp system. As seen in FIG. 6, the magnetic core in this embodiment is also integrated. The turn-ratio of the transformer is not necessarily 1 to 1.

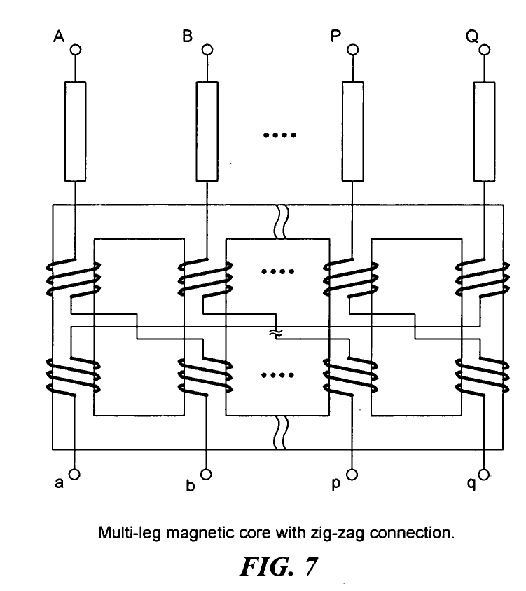

FIG. 7 shows that the proposed techniques of current balancing can be extended to more than 3-lamp systems by using integrated magnetic cores with more than 3 legs and zig-zag connection. Note that terminals A, B, . . . , P, and Q can be either directly connected to a high voltage capacitor or separately connected to several different capacitors. Therefore, the voltages on the terminals can either be common or phase-shifted or interleaved. In another embodiment, terminals a, b, . . . , p, and q are connected to the ground.

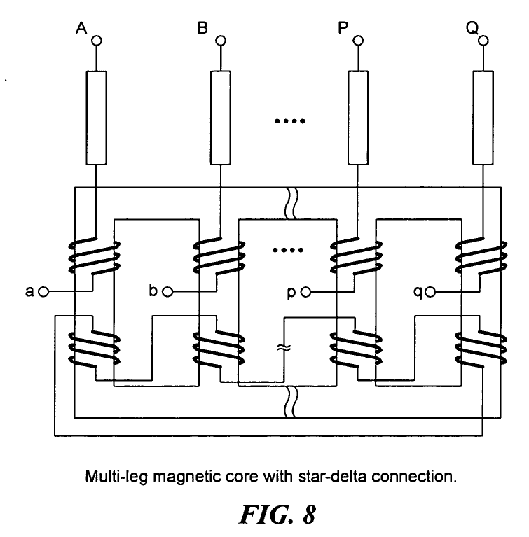

FIG. 8 illustrates a magnetic core with more than three legs and unconnected windings that can be either connected in accordance with the general winding principles disclosed in FIG. 6. Note that terminals A, B, . . . , P, and Q can be either directly connected to a high voltage capacitor or separately connected to several different capacitors. Therefore, the voltages on the terminals could be either common or phase-shifted or interleaved. In another embodiment, terminals a, b, . . . , p, and q are connected to the ground.

In most embodiments with substantially identical leg cross sections the primary windings of the legs are substantially similar to each other and the secondary windings of the legs are also substantially similar to each other. Furthermore, all connections of the two windings of each leg are similar to the connections of the two windings of any other leg. However, the primary and the secondary windings of each leg are wound in opposite directions. In the following paragraphs, to simplify the description of different transformers, all windings which are shown to have been wound in one direction are called the primary windings, and those windings which are in an opposite direction are called the secondary windings.

In some embodiments the secondary windings of all legs are connected in series and form a loop, while one end of each primary winding is connected to one end of a respective lamp and the other end of each primary winding is connected to the ground. In some of the other embodiments the primary winding of each leg is connected at one end to one end of a lamp and at the other end to one end of the secondary winding of another leg, and the other end of the secondary windings of the legs are connected to ground. The connections of the 4-winding arrangement of FIG. 5 is an exception to these general directives; however, like other described windings, the inductance is balanced in all wound legs.

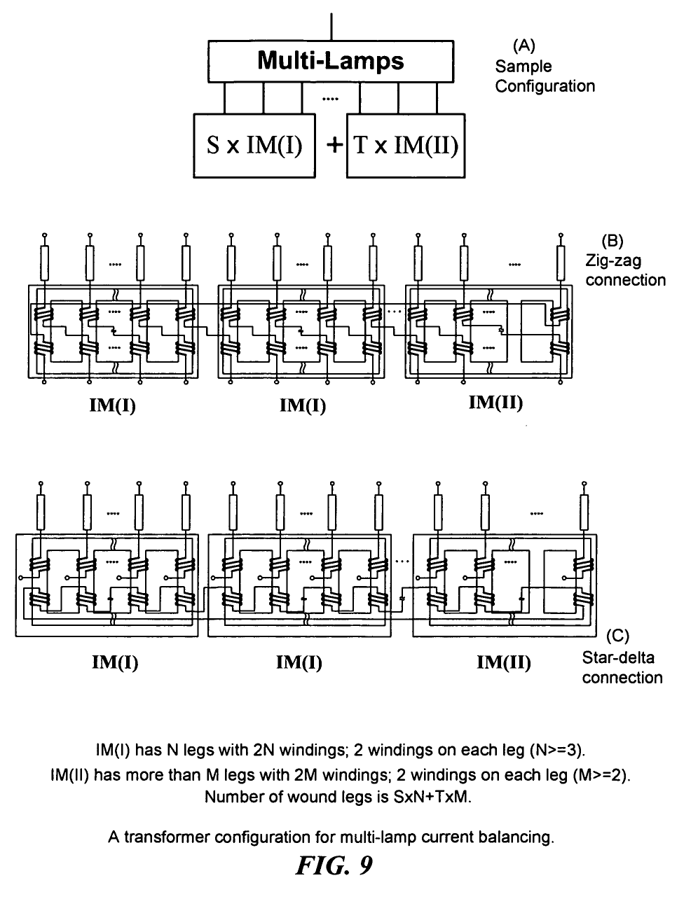

Since it is difficult to manufacture a transformer with a large number of core legs for driving many lamps, several different transformers with smaller number of legs, such as the readily available 3-leg EE type cores, can be utilized for current balancing. FIG. 9A illustrates an example of such arrangement in which at least 3-leg magnetic cores, with two windings on all legs, IM (I), or on less than all legs but more than one leg, IM (II), are used to power and balance the currents of a system with many lamps. FIGS. 9B and 9C show an example of a zig-zag and a star-delta connection for the arrangement schematically illustrated in FIG. 9A. In the exemplary FIGS. 9B and 9C, S is the number of the IM (I) cores and T is the number of the IM (II) cores. Note that more than two types of cores and/or windings may be used to drive multiple lamps.

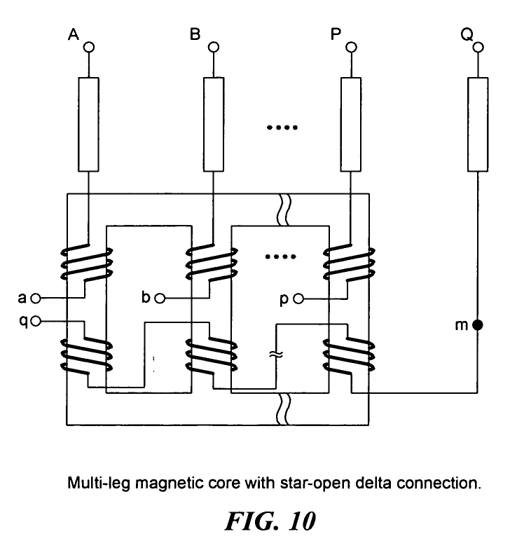

FIG. 10 illustrates an N-leg magnetic core with star-open-delta connection to balance currents in N+1 lamps, in accordance with yet anther embodiment of the invention. In this embodiment, the first and the second windings are configured such that the first winding of each of the N wound legs, from one similar end, is connected to one of N lamps and from another end to the ground, and the second windings of the wound legs are connected in series, wherein one end of the winding series is connected to the (N+1)th lamp and the other end of the winding series is connected to the ground.

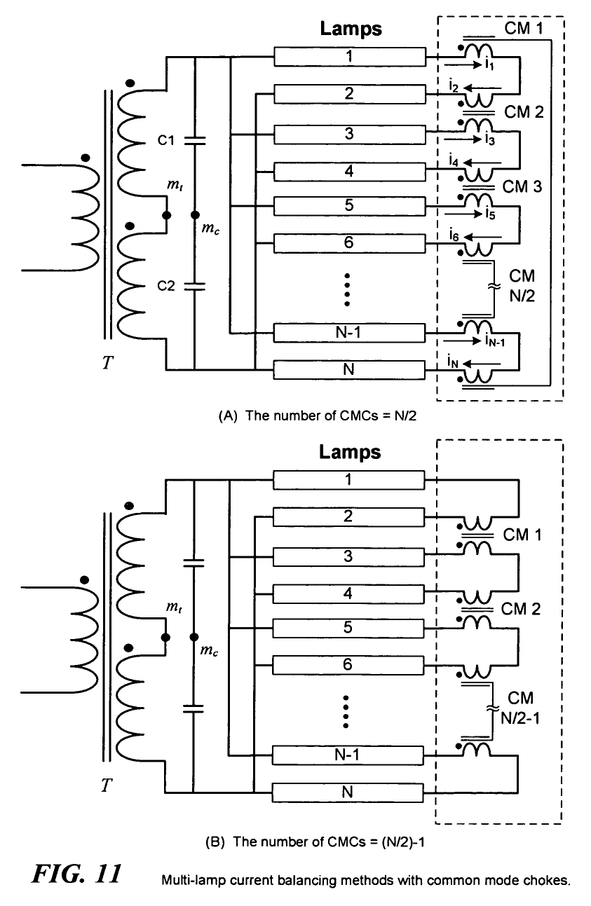

FIG. 11A shows a current balancing method using common mode chokes (CMCs). The circuit consists of a main transformer, capacitors, lamps, and CMCs. The center-taps mₜ and m_{c} of the transformer, T, secondary windings and capacitors C1 and C2 may be either grounded or floating. As shown in FIG. 11A, the number of CMCs required for the circuit is N/2 (CM₁ through CM_{N/2}). Because the CMCs force the following relations between the instantaneous loop currents:
i₁=i_{N},i₂=i₃,i₄=i₅, . . . ,i_{N-2}=i_{N-1}, (5)
and because:
i₁=i₂,i₃=i₄,i₅=i₆, . . . ,i_{N-1}=i_{N}, (6)
therefore,
i₁=i₂=i₃=i₄=i₅, . . . ,i_{N-1}=i_{N}. (7)

FIG. 11B illustrates a similar current balancing method; however, the number of CMCs required for the circuit shown in FIG. 11B is (N/2)−1 (CM₁ through CM_{N/2-1}). Furthermore, the CMCs in FIGS. 11A and 11B can either be separate or integrated, as described above, offering different advantages. By using the methods illustrated in FIGS. 11A and 11B, the number of CMCs for driving N lamps is reduced to N/2 or (N/2)−1. In other embodiments every several lamps may use an integrated core; for example every six lamps may use a 3-legged EE type core.

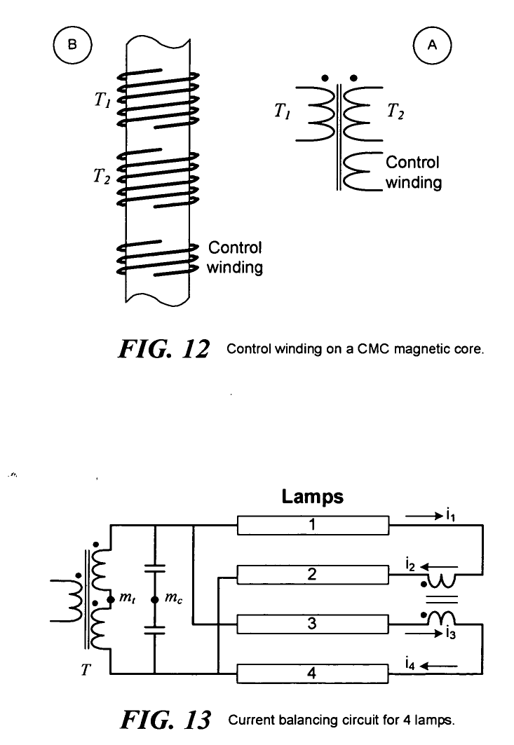

FIGS. 12A and 12B illustrate the winding details of a CMC, in accordance with yet another embodiment of the invention. T₁ and T₂ are the CMC primary and secondary windings, respectively, with an added control winding. The existence of a voltage across the control winding is an indication of an abnormal circuit function, since under normal conditions, due to the flux cancellation, there should be no potential difference across the control winding. For example, under an open lamp loop condition, a voltage will be detected across this small control winding, which simplifies fault protection while the control winding is inexpensive and easy to manufacture.

FIG. 13 shows a current balancing method for a 4-lamp application, using a single CMC while the existing current balancing methods for a 4-lamp application use four CMCs. The circuit shown in FIG. 13 provides good performance at a low cost. In one embodiment the CMC for a 4-lamp application uses readily available EE type cores. For the same reason illustrated by equations (5), (6), and (7), the instantaneous currents in the four lamps shown in FIG. 13 are equal.

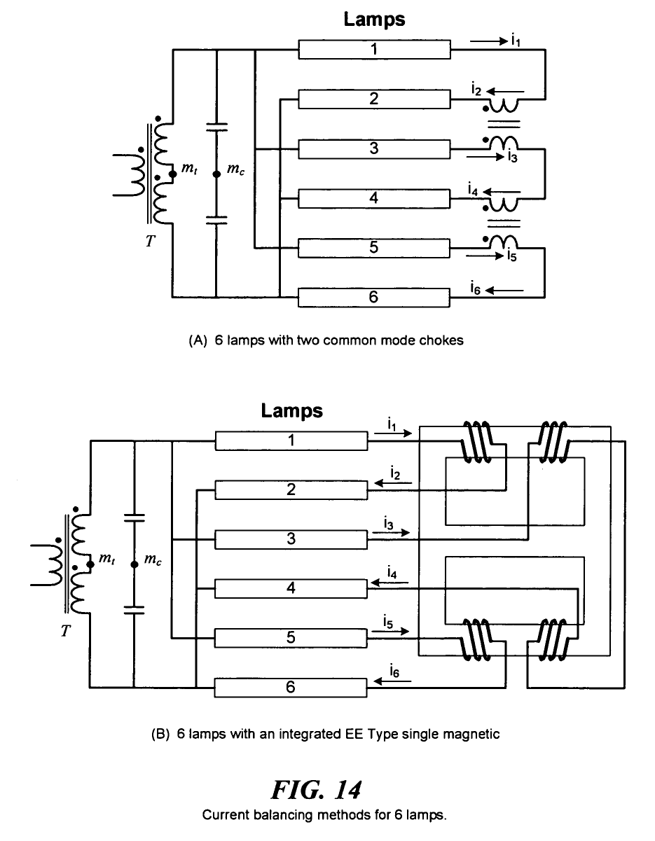

FIG. 14A shows a method of current balancing for a 6-lamp application. This method only uses two CMCs. For the same reason illustrated by equations (5), (6), and (7), the instantaneous currents in the six lamps shown in FIG. 14A are equal. FIG. 14B illustrates an integrated method of implementing the CMCs of FIG. 14A. As shown in FIG. 14B, the two CMCs are wound on a same magnetic core; in this case an EE type. In an alternative embodiment, a control winding is placed on the center leg of the EE core to detect defects such as an open lamp condition. The method disclosed in this embodiment reduces the number of CMCs required for balancing current in the lamp loops.

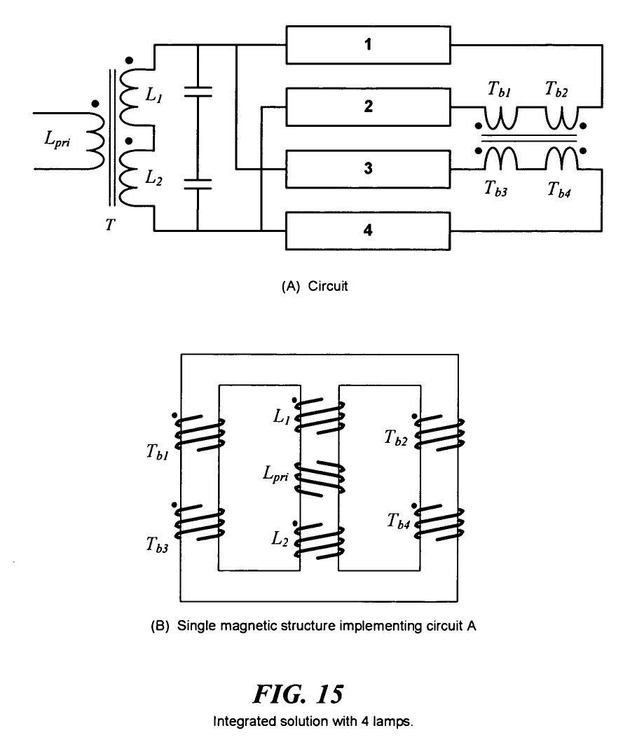

FIG. 15A illustrates a method of integrating the transformer T and the CMC of FIG. 13 onto a single magnetic, to achieve current balancing. The integrated magnetic includes all windings shown in FIG. 15A: Lₚᵣᵢ, L₁, L₂, T_{b1}, T_{b2}, T_{b3}, and T_{b4}, where Lₚᵣᵢ is the primary winding of the main transformer T, L₁ and L₂ are the secondary windings and T_{b1}, T_{b2}, T_{b3}, and T_{b4} are the CMC windings for current balancing. FIG. 15B shows the magnetic core and detail winding connections. One of the advantages of this embodiment is the simplicity of the required magnetic core and its associated cost.

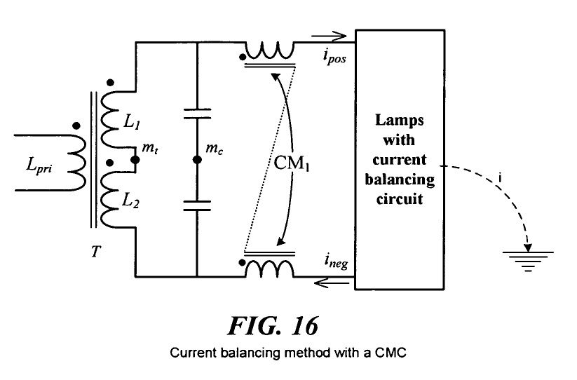

FIG. 16 shows a method of leakage prevention for multiple lamps, using a single CMC, wherein the multiple lamps may or may not use additional current balancing means. Ideally, the current entering the lamps (Iₚₒₛ) must be equal to the current exiting the lamps (I_{neg}); however, with long lamps there may be a leakage current at high frequencies from the lamps to ground (e.g., earth or chassis), due to a capacitor coupling between the lamps and the ground. In the disclosed configuration of FIG. 16, the common mode choke CM₁, balances Iₚₒₛ and I_{neg} currents in an effort to minimize the leakage.

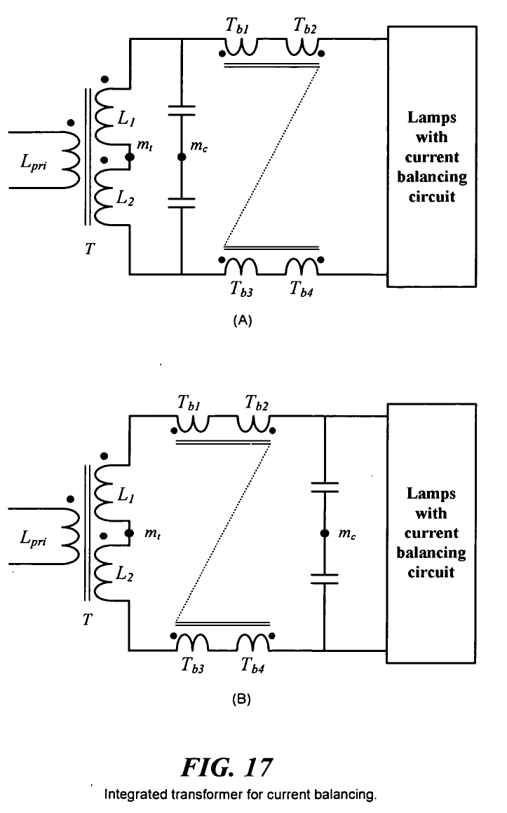

FIGS. 17A and 17B show a current balancing and leakage minimization method, similar to the one illustrated in FIG. 16, employing a single magnetic core on which the main transformer T and the CMCs are wound, wherein the winding connections are made according to FIG. 15B. The CMCs are placed either in series with the lamps, as shown in FIG. 17A, or with the transformer secondary winding, as shown in FIG. 17B.

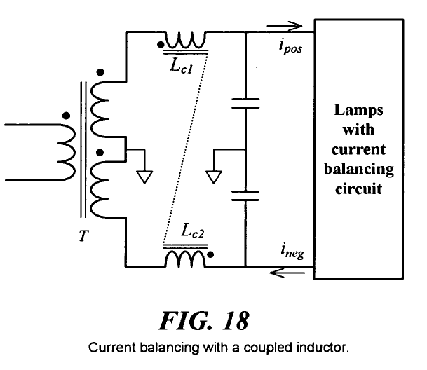

FIG. 18 shows a current balancing method with a coupled inductor, L_{c1} and L_{c2}. Typically, the main transformer T includes enough leakage inductance for CCFL applications, while the leakage fluxes flow through air and generate loss, which is extremely high at high power levels. In this embodiment of the invention, the main transformer T has a lower leakage inductance but the coupled inductor helps the transformer to form an adequate resonant tank while equalizing lamp currents (Iₚₒₛ and I_{neg}) by providing identical voltages across the two windings. This improves efficiency at high power settings.

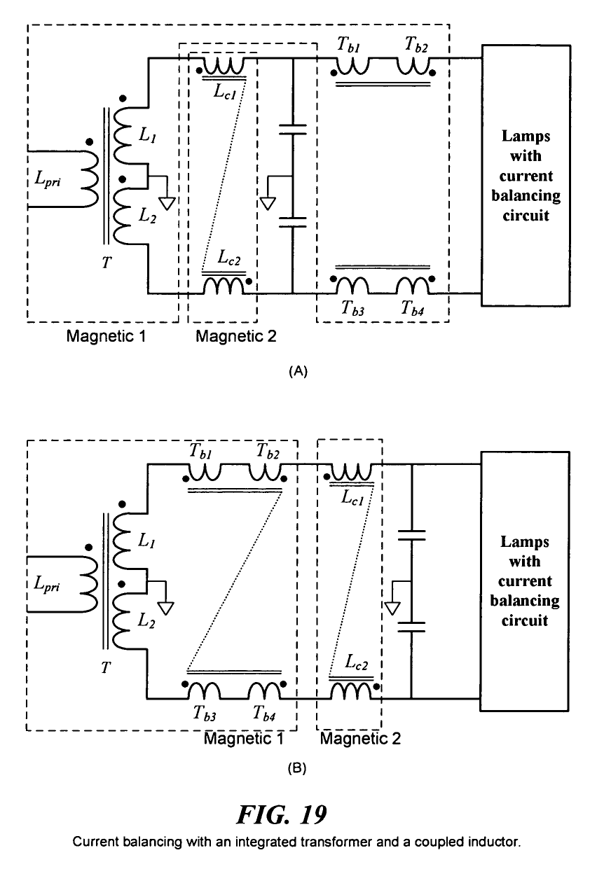

FIGS. 19A and 19B show a lamp current balancing method with an integrated magnetic core for the main transformer T and the CMCs to improve performance. This embodiment combines the advantages offered by the embodiments depicted in FIGS. 17 and 18. The dashed lines in FIGS. 19A and 19B illustrate two possible integration options for reducing cost and space, and for simplifying manufacturing.

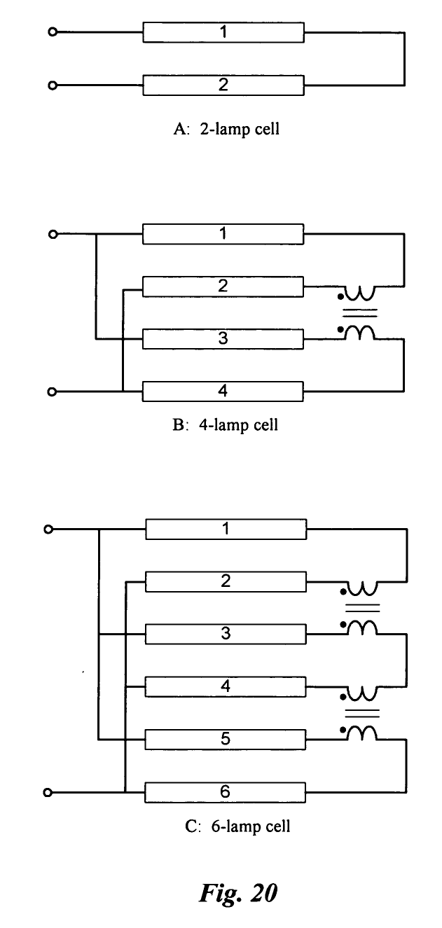

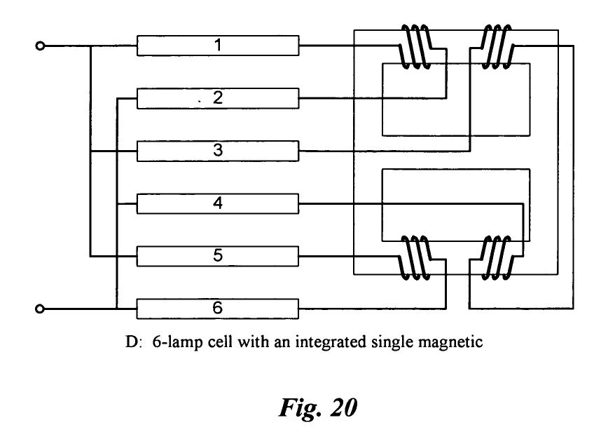

FIGS. 20A-20D schematically illustrate some of the disclosed methods that achieve current balancing for 2, 4, and 6 lamps, and in each of which the lamp currents are identical. Hereinafter each combination, for the ease of referencing, is called a “cell.”

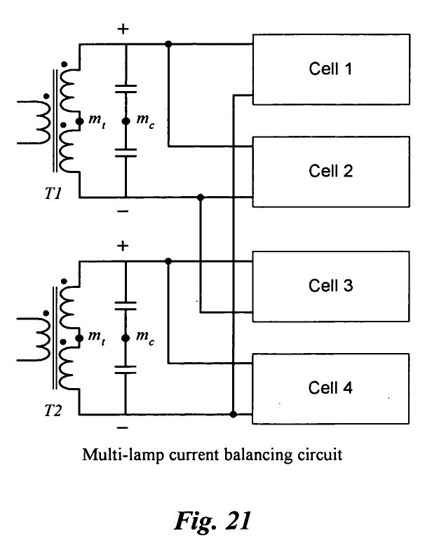

FIG. 21 discloses a multi-lamp current-balancing circuit in which the currents of 8 lamps or more are balanced. FIG. 21 depicts this embodiment at the cell level, wherein each cell is connected between a positive and a negative terminal of two transformers, T1 and T2. The cells shown in FIG. 21 can be, for example, any of the cells shown in FIG. 20. As can be seen in FIG. 21, none of the depicted cells is in parallel with any other cell and each cell is independent of any other cell. Cell 1 is connected between the positive side of the secondary winding of T1 and the negative side of the secondary winding of T2. Cell 2 is connected between the positive side of the secondary winding of T1 and the negative side of the secondary winding of T1. Cell 3 is connected between the positive side of the secondary winding of T2 and the negative side of the secondary winding of T1. And Cell 4 is connected between the positive side of the secondary winding of T2 and the negative side of the secondary winding of T2. In one embodiment there is at least one capacitor between the two sides of the secondary winding of each of the T1 and T2 transformers which are used to make a resonant circuit with a leakage inductance on transformer T1. In some embodiments the midpoints mₜ and m_{c} are connected to the ground, where mₜ is the midpoint of the T1 and T2 secondary windings and m_{c} is the midpoint of the capacitance connected between the two sides of these secondary windings.

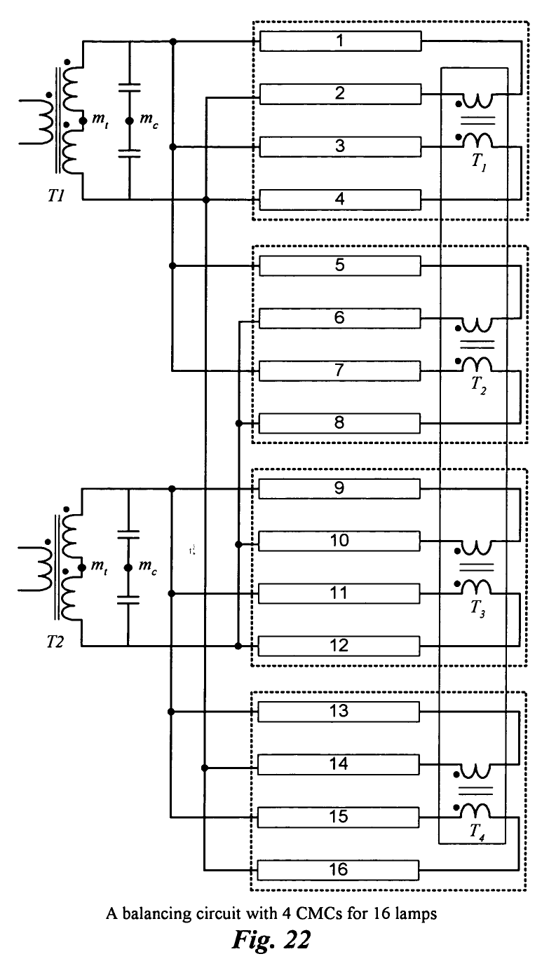

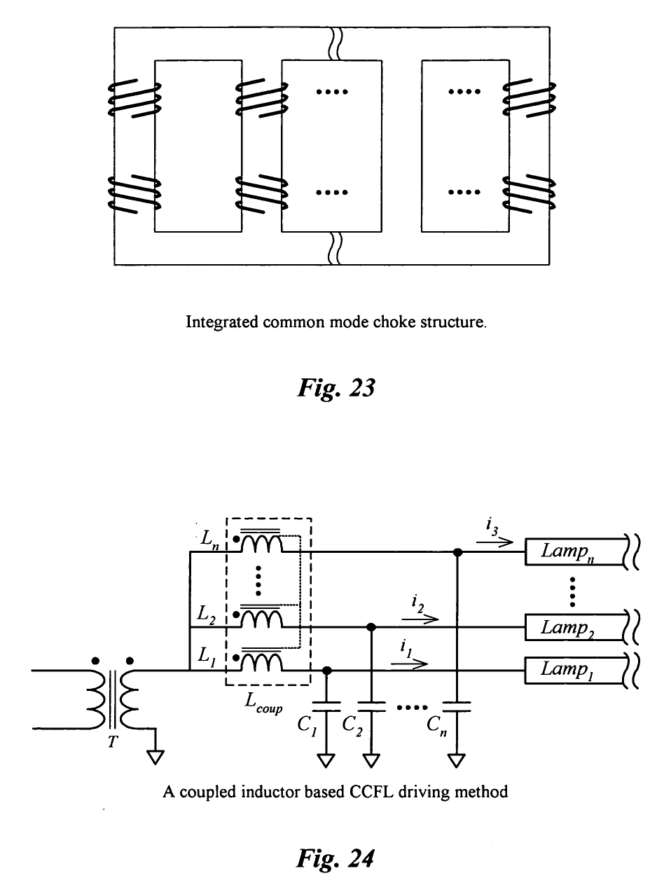

FIG. 22 shows details of an exemplary circuit, which is similar to the circuit of FIG. 21, wherein 4-lamp cells such as the one depicted in FIG. 20B, are utilized for a total of 16 lamps. This approach accommodates all possible lamp combinations, such as 14, 16, 18, and 20 lamps. This exemplary circuit only needs 4 CMCs, which can be integrated into a single magnetic M. The magnetic M can be a single or a multi-core magnetic structure. As an example, FIG. 23 shows a single CMC structure to be used in the circuit of FIG. 22.

FIG. 24 shows a current balancing solution that uses a coupled inductor. The coupled inductor has several windings on a single core. This current balancing embodiment makes all lamps work independently while being balanced. From the other side, not shown in the Figure, the lamps can be connected to GND or a similar circuit on the other side.

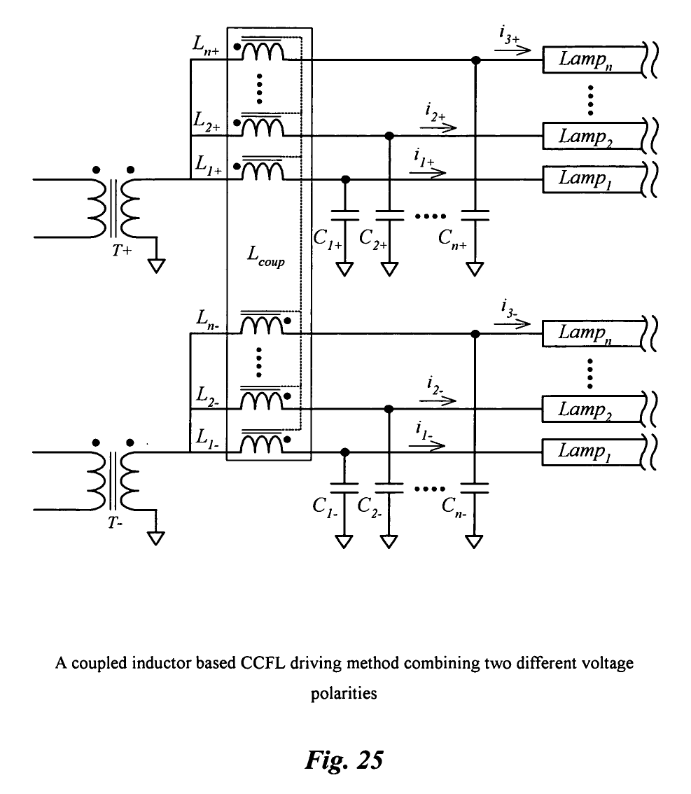

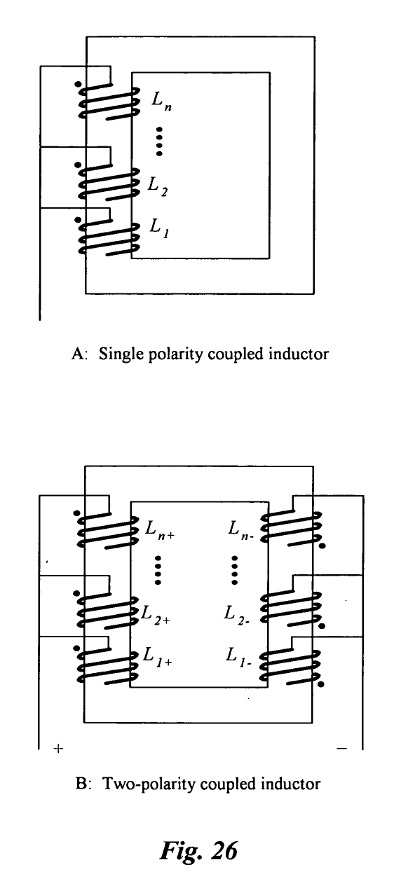

FIG. 25, while somewhat similar to FIG. 24, depicts multiple lamps utilizing two different voltage sources, T+ and T−, through a coupled inductor. The outputs of T+ and T− are typically out of phase. This embodiment illustrates how two different voltage sources are used along with a coupled inductor to balance currents in multiple CCFLs. As an example of coupled inductors, FIGS. 26A and 26B illustrate a single and a two polarity coupled inductor which can be employed in the circuits of FIGS. 24 and 25.

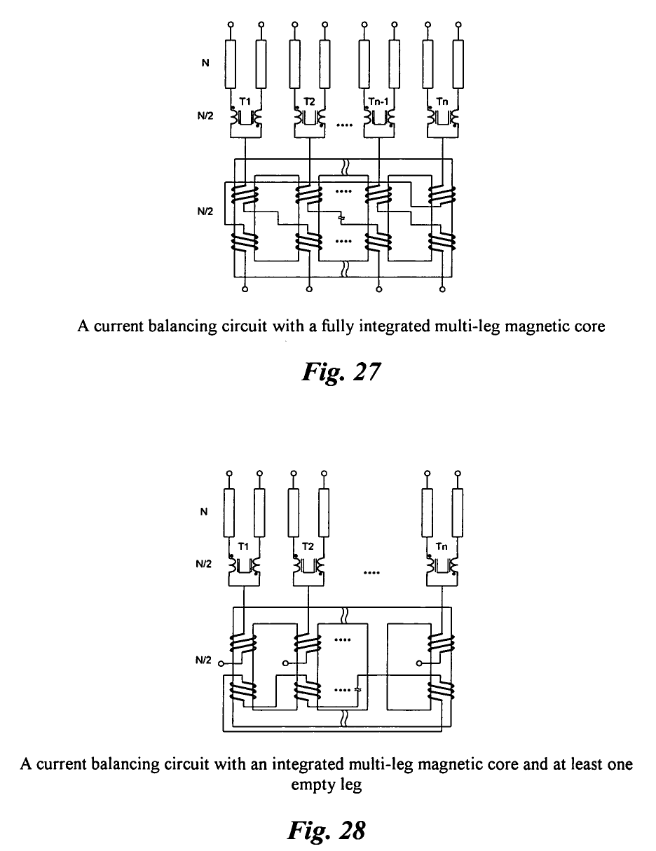

FIG. 27 shows a lamp current balancing circuit with a fully integrated multi-leg magnetic core. This multi-leg transformer has a zig-zag connection. T1 to Tn CMCs can be integrated with one of the mentioned multi-leg solutions such as the one shown in FIG. 23.

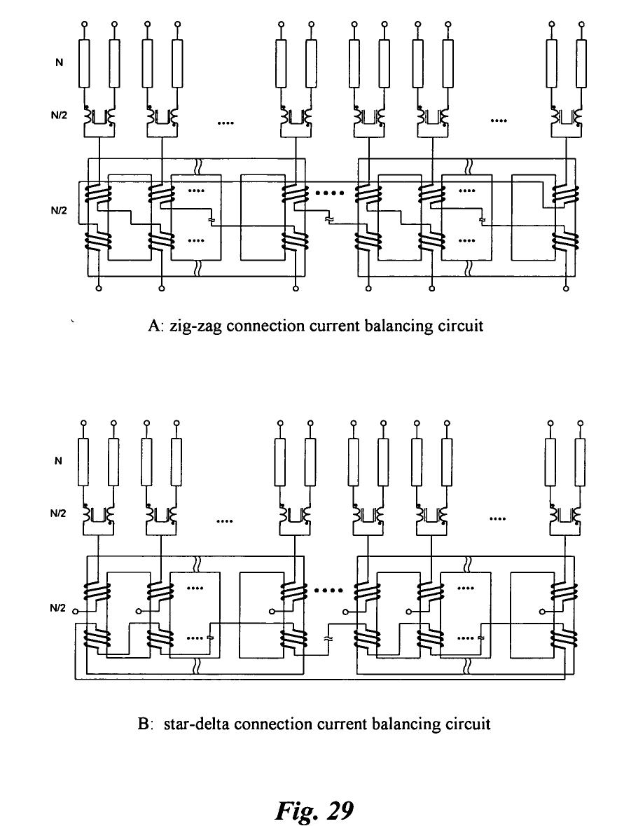

FIG. 28 shows another solution that has a star-delta connection on a multi-leg transformer with at least one empty leg on which there are no windings. As shown in FIG. 29, the solutions illustrated in FIGS. 27 and 28 extend the current balancing to numerous lamps. As an example, FIG. 29 illustrates how the windings of separate transformers can be connected to balance the currents in N lamps that are fed by these transformers.

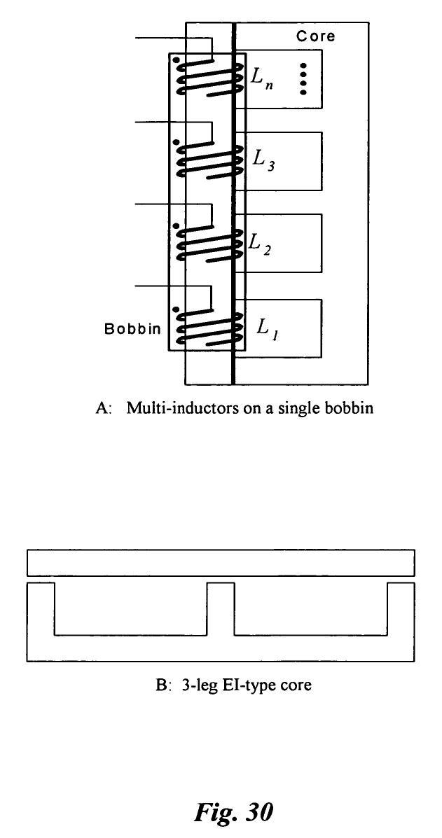

As shown in FIG. 30A, the inductors of FIG. 24 may be replaced with multi-inductors on a single bobbin, where the core is an EI-type, depicted in FIG. 30B, and where the number of core legs is equal or greater than 3.

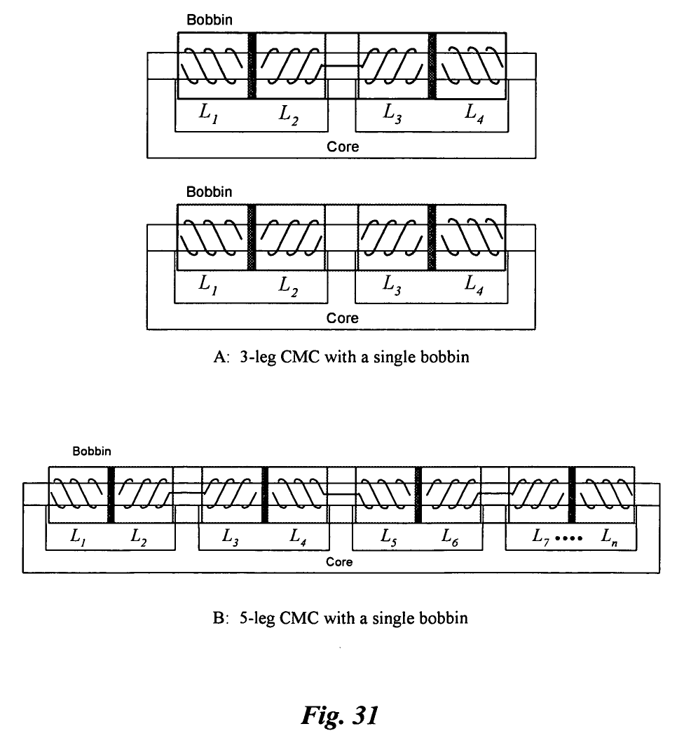

Similarly, FIGS. 31A and 31B show multi-CMCs with a single bobbin structure. A 3-leg CMC is shown in FIG. 31A, and a 5 leg CMC in FIG. 31B. The bobbin may have several sections to support high voltages across the windings. For example, if the voltage is 1000V, a four section bobbin is needed where each section handles 300V. In FIGS. 31A and 31B, L2 is directly connected to L3 on the bobbin or L2 may be separate from L3. Some or all aspects of these embodiments can be applied to different kinds of load balancing situations, utilizing inexpensive solutions which fully exploit magnetic circuits, their manufacturing, and their integration with electronic components and ICs.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof.

Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. Changes can be made to the invention in light of the above Detailed Description. While the above description describes certain embodiments of the invention, and describes the best mode contemplated, no matter how detailed the above appears in text, the invention can be practiced in many ways. Details of the compensation system described above may vary considerably in its implementation details, while still being encompassed by the invention disclosed herein.

The teachings of the invention provided herein can be applied to other systems, not necessarily the system described above. The elements and acts of the various embodiments described above can be combined to provide further embodiments.

The terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

We/I claim:

1. An apparatus for balancing lamp currents of four lamp-cells, wherein each lamp-cell comprises multiple balanced lamps, and wherein each lamp-cell has two electrical ports, the apparatus comprising:
a first transformer T1, having a primary and a secondary winding, wherein a capacitor is connected between a first and a second end of the secondary winding;
a second transformer T2, having a primary and a secondary winding, wherein a capacitor is connected between a first and a second end of the secondary winding; and
a balancing circuit wherein:
one electrical port of a first lamp-cell is connected to the first end of the secondary winding of T1 and the other electrical port of the first lamp-cell is connected to the second end of the secondary winding of T2;
one electrical port of a second lamp-cell is connected to the first end of the secondary winding of T1 and the other electrical port of the second lamp-cell is connected to the second end of the secondary winding of T1;
one electrical port of a third lamp-cell is connected to the first end of the secondary winding of T2 and the other electrical port of the third lamp-cell is connected to the second end of the secondary winding of T1; and
one electrical port of a fourth lamp-cell is connected to the first end of the secondary winding of T2 and the other electrical port of the fourth lamp-cell is connected to the second end of the secondary winding of T2.

2. The apparatus of claim 1, wherein each lamp-cell with more than two lamps has at least one common mode choke (CMC) and the CMCs are separate, integrated, or a number of the CMCs are separate and a number of the CMCs are integrated.

3. The apparatus of claim 1, wherein each lamp-cell with more than two lamps has at least one common mode choke (CMC) and the CMCs are integrated on an “EE” or “EI” type magnetic cores, and wherein the “I” part of the EI magnetic core includes one bobbin on which windings of the CMCs are wound.

4. The apparatus of claim 1, wherein each lamp-cell comprises:
two lamps connected in series;
four lamps, wherein a first lamp, a first winding of a common mode choke (CMC), and a second lamp are connected in series between the electrical ports of the lamp-cell, and wherein a third lamp, a second winding of the CMC, and a fourth lamp are connected in series between the electrical ports of the lamp-cell; or
six lamps, wherein a first lamp, a first winding of a first CMC, and a second lamp are connected in series between the electrical ports of the lamp-cell, and wherein a third lamp, a second winding of the first CMC, a first winding of a second CMC, and a fourth lamp are connected in series between the electrical ports of the lamp-cell, and wherein a fifth lamp, a second winding of the second CMC, and a sixth lamp are connected in series between the electrical ports of the lamp-cell.

5. The apparatus of claim 4, wherein the two windings of each CMC are wound on one leg of an N-leg magnetic core, where N is more than the number of CMCs.

6. The apparatus of claim 1, wherein midpoints of the T1 and T2 secondary windings and of the capacitance connected between these secondary windings are connected to ground or a common point.

7. An apparatus for balancing lamp currents in N lamps, the apparatus comprising:
an alternating power supply, wherein a first pole of the power supply is connected to a common point;
a coupled inductor, wherein first ends of N windings of the coupled inductor are connected to a second pole of the power supply, and wherein each second end of the N windings of the coupled inductor is connected to a first end of one of the N lamps, and wherein the second ends of the N lamps are connected to the common point or to similar points of a similar circuit such that the two circuits are symmetric with respect to connection points; and
N capacitors, each of which mounted between the first end of one of the N lamps and the common point.

8. The apparatus of claim 7, wherein the coupled inductor utilizes multiple windings on a single magnetic core.

9. An apparatus for balancing lamp currents in 2N lamps, the apparatus comprising:
a first power supply, wherein a first pole of the first power supply is connected to a common point;
a coupled inductor with at least 2N windings, wherein a first end of a first group of N windings of the coupled inductor is connected to a second pole of the first power supply, and wherein each second end of the first group of N windings of the coupled inductor is connected to a first end of one of a first group of N lamps, and wherein the second ends of the first group of N lamps are connected to the common point or to similar points of a similar circuit such that the two circuits are symmetric with respect to connection points;
a second power supply, wherein a first pole of the second power supply is connected to the common point, and wherein a first end of a second group of N windings of the coupled inductor is connected to a second pole of the second power supply, and wherein each second end of the second group of N windings of the coupled inductor is connected to a first end of one of a second group of N lamps, and wherein the second ends of the second group of N lamps are connected to the common point or to similar points of a similar circuit such that the two circuits are symmetric with respect to connection points; and
2N capacitors, each of which mounted between the first end of one of the 2N lamps and the common point.

10. The apparatus of claim 9, wherein the first power supply is a secondary winding of a first transformer and the second power supply is a secondary winding of a second transformer.

11. The apparatus of claim 9, wherein the coupled inductor utilizes multiple windings on a single magnetic core.

12. An apparatus for balancing lamp currents in 2N lamps, the apparatus comprising:
N common mode chokes (CMCs), wherein a first side of each of two windings of each CMC is connected to a first side of one of the 2N lamps and a second side of the two windings of each CMC is connected together to form N connection points, and wherein the second sides of the lamps are connected to a first pole of a power source; and
an N-leg magnetic core having a first and a second winding on each leg, wherein each connection point is connected to a first end of a first magnetic core winding, and wherein:
the first and second magnetic core windings are connected in zig-zag connection such that one end of each of the second magnetic core winding is free to be connected to the second pole of the power supply; or
the first magnetic core windings form a star connection and second magnetic core windings form a delta connection such that the second end of each of the first magnetic core winding is free to be connected to the second pole of the power supply.

13. The apparatus of claim 12, wherein the N CMCs are separate, integrated, or a number of the CMCs are separate and a number of the CMCs are integrated.

14. The apparatus of claim 12, wherein the N-leg magnetic core is divided into multiple magnetic cores, wherein the total number of legs is at least N.

15. The apparatus of claim 12, wherein the CMC is integrated on a multi-leg “EE” or “EI” type magnetic core, where the number of legs is at least three.

16. An apparatus for balancing load currents of four load-cells, wherein each load-cell comprises multiple loads, and wherein each load-cell has two electrical ports, the apparatus comprising:
a first power supply T1;
a second power supply T2; and
a balancing circuit wherein:
a first load-cell is connected between the first output pole of T1 and the second output pole of T2;
a second load-cell is connected between the first output pole of T1 and the second output pole of T1;
a third load-cell is connected between the first output pole of T2 and the second output pole of T1; and
a first load-cell is connected between the first output pole of T2 and the second output pole of T2.

17. The apparatus of claim 16, wherein the first power supply is a secondary winding of a first transformer and the second power supply is a secondary winding of a second transformer and a capacitor is connected between a first and a second output pole of T1 and T2.

18. A method for balancing load currents of four load-cells, wherein each load-cell comprises multiple loads, and wherein each load-cell has two electrical ports, the method comprising:
connecting a first load-cell between the first output pole of a first power supply and the second output pole of the second power supply;
connecting a second load-cell between the first output pole of the first power supply and the second output pole of the first power supply;
connecting a third load-cell between the first output pole of the second power supply and the second output pole of the first power supply; and
connecting a first load-cell between the first output pole of the second power supply and the second output pole of the second power supply.

19. The method of claim 18, wherein each load-cell comprises:
two loads connected in series;
four loads, wherein a first load, a first winding of a common mode choke (CMC), and a second load are connected in series between the electrical ports of the load-cell, and wherein a third load, a second winding of the CMC, and a fourth load are connected in series between the electrical ports of the load-cell; or
six loads, wherein a first load, a first winding of a first CMC, and a second load are connected in series between the electrical ports of the load-cell, and wherein a third load, a second winding of the first CMC, a first winding of a second CMC, and a fourth load are connected in series between the electrical ports of the load-cell, and wherein a fifth load, a second winding of the second CMC, and a sixth load are connected in series between the electrical ports of the load-cell.

20. An apparatus for balancing lamp currents using at least one common mode choke (CMC) that utilizes a 3-leg “EI” type magnetic core where the “I” part of the EI magnetic core comprises a single bobbin, and wherein a first and a second windings are wound on the bobbin between a middle leg and one outer leg of the 3-leg EI magnetic core and a third and a fourth windings are wound on the bobbin between the middle leg and the other outer leg of the 3-leg EI magnetic core, and wherein the second and the third windings are electrically connected or separated, and wherein turns ratio of the windings are 1:1:1:1 or 1:N:N:1, respectively, and wherein the bobbin may have multiple sections.

21. An apparatus for balancing lamp currents using at least one common mode choke (CMC) that utilizes a multi-leg “EI” type magnetic core, and wherein the “I” part of the EI magnetic core includes one bobbin on which windings of the CMC are wound such that every two windings are located between two adjacent legs, and wherein each one of the two windings located between two adjacent legs is connected to one winding located between neighboring adjacent legs.
